(19) United States
(12) Patent Application Publication
(10) Pub. No.: US 2010/0130376 A1
(43) Pub. Date: May 27, 2010

(54) DNA CHIP FOR PREDICTION OF OCCURRENCE OF LATE ADVERSE REACTION IN URINARY ORGAN AFTER RADIOTHERAPY, AND METHOD FOR PREDICTION OF OCCURRENCE OF LATE ADVERSE REACTION IN URINARY ORGAN AFTER RADIO THERAPY USING THE SAME

(75) Inventors: Takashi Imai, Chiba (JP); Mayumi Iwakawa, Chiba (JP); Eisei Oda, Tokyo (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: National Institute of Radiological Sciences, Chiba (JP)

(21) Appl. No.: 12/452,500

(22) PCT Filed: Jul. 7, 2008
(86) PCT No.: PCT/JP2008/062297

§ 371 Date: Jan. 5, 2010

Related U.S. Application Data
(60) Provisional application No. 60/929,662, filed on Jul. 6, 2007.

(51) Int. Cl. C40B 30/04; C40B 40/08

(52) U.S. Cl. 506/9; 506/17

(57) ABSTRACT

A DNA chip and a prediction method for predicting the occurrence of a late adverse reaction in a urinary organ after C-ion RT are provided. The DNA chip comprises a supporting means for supporting a DNA probe thereon, and a plurality of genetic markers supported on the supporting means. The prediction method comprises a first step of hybridizing a genetic marker with a labeled DNA prepared from a subject to be examined, a second step of identifying bases of both alleles of the labeled DNA hybridized with the genetic marker, and a third step of determining a genotype of the labeled DNA as a risk genotype if the combination of the identified bases corresponds to the specified combination, and predicting that the subject is predisposed to develop a late adverse reaction in a urinary organ after radiotherapy when the number of the risk genotypes is three or more and the subject is not predisposed to develop a late adverse reaction in a urinary organ after radiotherapy when the number of the risk genotypes is two or less. The method enables to predict whether or not a subject is affected with a late adverse reaction in a urinary organ after radiotherapy.

### BACKGROUND OF THE INVENTION

1. Field of the Invention

The present invention relates to a DNA chip for predicting occurrence of a late adverse reaction in a urinary organ after radiotherapy, and a method of predicting occurrence of a late adverse reaction in a urinary organ after radiotherapy using the same.

2. Description of the Related Art

Prostate cancer (PCa) is one of the leading causes of cancer death in men in developed countries (Jemal A, Seiegal R, Ward E, et al. “Cancer statistics, 2006.”, CA Cancer J Clin, 2006, 56, p 106 to 130).

Recently, carbon ion radiotherapy (C-ion RT) with an established dose fractionation regimen has been shown to yield biochemically satisfactory relapse-free rates without local recurrence and with minimal adverse reaction (Orecchia R, Zurlo A, Loasses A, et al. “Particle beam therapy (hadrontherapy): Basis for interest and clinical experience”, Eur J Cancer, 1998, 34, p 459 to 468; Nikoghosyan A, Schulz-Ertner D, Didinger B, et al. “Evaluation of therapeutic potential of heavy ion therapy for patients with locally advanced prostate cancer.”, Int J Radiat Oncol Biol Phys, 2004, 58, p 89 to 97; Tsuji H, Yanagi T, Ishikawa H, et al. “Hypofractionated radiotherapy with carbon ion beams for prostate cancer.”, Int J Radiat Oncol Biol Phys, 2005, 63, p 1153 to 1160; Ishikawa H, Tsuji H, Kamada T, et al. “Risk factors of late rectal bleeding after carbon ion therapy for prostate cancer.”, Int J Radiat Oncol Biol Phys, 2006, 66, p 1084 to 1091).

To establish an appropriate dose fractionation regimen for C-ion RT, Phase I to II and Phase II clinical studies were performed at the National Institute of Radiological Sciences in Japan (Tsuji H, Yanagi T, Ishikawa H, et al. “Hypofractionated radiotherapy with carbon ion beams for prostate cancer.”, Int J Radiat Oncol Biol Phys, 2005, 63, p 1153 to 1160; Ishikawa H, Tsuji H, Kamada T, et al. “Risk factors of late rectal bleeding after carbon ion therapy for prostate cancer.”, Int J Radiat Oncol Biol Phys, 2006, 66, p 1084 to 1091; Akakura K, Tsujii H, Morita S, et al. “Phase I/II clinical trials of carbon ion therapy for prostate cancer.”, Prostate, 2004, 58, p 252 to 258). These studies demonstrated that C-ion RT was an effective and safe treatment option. Neither Grade 3 nor greater late radiation toxicities were observed in either the rectum or genitourinary system, and the incidence of Grade 2 rectal and genitourinary morbidities was only 1.0% and 6.0%, respectively (Tsuji H, Yanagi T, Ishikawa H, et al. “Hypofractionated radiotherapy with carbon ion beams for prostate cancer.”, Int J Radiat Oncol Biol Phys, 2005, 63, p 1153 to 1160).

Because some of the patients susceptible to radiotherapy (RT) might be included in the patients of the clinical studies, investigation of genetic factors of the patients provides important information for predicting individual radiosensitivity.

This will facilitate the development of methods that can predict the risk of adverse effects after, not only C-ion RT, but also conventional photon RT, even though adverse effects to RT occurred in only a small number of patients who had undergone C-ion RT.

Several observations have indicated that the heterogeneity of adverse normal tissue reactions in cancer patients treated with RT could result from the combined effects of several different genetic alterations (Andreassen C N, Alsner J, Overgaard J. “Dose variability in normal tissue reactions after radiotherapy have a genetic basis-Where and how to look for it?”, Radiother Oncol, 2002, 64, p 131 to 140; Andreassen C N, Alsner J, Overgaard M, et al. “Prediction of normal tissue radiosensitivity from polymorphisms in candidate genes”, Radiother Oncol, 2003, 69, p 127 to 135).

To date, only a few reports have described the genetic markers associated with an increased risk of adverse reactions after RT in PCa patients.

Cesaretti et al. indicated that sequence variations in ATM were predictive of adverse responses after ¹²⁵I branchy therapy (Cesaretti J A, Stock R G, Lehrer S, et al. “ATM sequence variants are predictive of adverse radiotherapy response among patients treated for prostate cancer”, Int J Radiat Oncol Biol Phys, 2005, 61, p 196 to 202). Moreover, Peters et al. have demonstrated that single nucleotide polymorphisms (hereinafter, referred to a SNP or SNPs) in the TGFb1 gene were predictive of the development of adverse quality-of-life outcomes (Peters C A, Stock R G, Cesaretti J A, et al. “TGFB1 Single nucleotide polymorphisms are associated with adverse quality of life in prostate cancer patients treated with radiotherapy”, Int J Radiat Oncol Biol Phys, 2008, 70, p 752 to 759).

Recently, Damaraju et al. examined 49 SNPs in 24 DNA repair and steroid metabolism genes using a large scale candidate-gene approach, and identified SNPs associated with an increased risk of Grade 2 or greater late bladder or rectal toxicity after three-dimensional conformal RT in the LIG4, ERCC2, and CYP2D6*4 genes. However, such SNPs were not in the ATM or TGFB1 genes (Damaraju S, Murray D, Dufour J, et al. “Association of DNA repair and steroid metabolism gene polymorphisms with clinical late toxicity in patients treated with conformal radiotherapy for prostate cancer”, Clin Cancer Res, 2006, 12, p 2545 to 2554).

The combined effects of these genetic markers, together with clinical factors such as bladder dose, dose to 30% of the rectal volume, and patient age, were also reported (Damaraju S, Murray D, Dufour J, et al. “Association of DNA repair and steroid metabolism gene polymorphisms with clinical late toxicity in patients treated with conformal radiotherapy for prostate cancer”, Clin Cancer Res, 2006, 12, p 2545 to 2554).

Further, Suga et al. reported 118 candidate genes for investigating late genitourinary adverse reaction after C-ion RT. (Suga T, Ishikawa A, Kohda M, et al. “Haplotype-based analysis of genes associated with risk of adverse skin reactions after radiotherapy in breast cancer patients”, Int J Radiat Oncol Biol Phys, 2007 69, p 685 to 693)

It is unclear whether these variations reported in the above mentioned documents were associated with the risk of adverse RT effect in all PCa patients.

Accordingly, there was no means or method of predicting occurrence of a late adverse reaction in a urinary organ after C-ion RT.

### SUMMARY OF THE INVENTION

The present invention has been made in view of the above mentioned problem. It is an object of the present invention to provide a DNA chip for predicting occurrence of a late adverse reaction in a urinary organ after C-ion RT, and a method of predicting occurrence of a late adverse reaction in a urinary organ after radiotherapy using the same.

In order to overcome the above mentioned problem, the present inventors have diligently studied the association between SNPs in 118 candidate genes (Suga T, Ishikawa A, Kohda M, et al. “Haplotype-based analysis of genes associated with risk of adverse skin reactions after radiotherapy in breast cancer patients.”, Int J Radiat Oncol Biol Phys, 2007, 69, p 685 to 693) and radiosensitivity regarding a late adverse urinary reaction after C-ion RT, and attained the present invention.

A DNA chip for predicting an occurrence of a late adverse reaction in a urinary organ after radiotherapy of the present invention which solves the above mentioned problem comprises: a supporting means for supporting a synthesized DNA probe; and a plurality of genetic markers supported on the supporting means. Herein, the plurality of the genetic markers include: (a) a set of DNA probes comprising a DNA probe including an allele of which base encoded by rs2276105 is G or a DNA probe including the allele with a complementary strand thereof, and a DNA probe including the other allele of which base encoded by rs2276015 is A or a DNA probe including the allele with a complementary strand thereof; (b) a set of DNA probes comprising a DNA probe including an allele of which base encoded by rs2742946 is C or a DNA probe including the allele with a complementary strand thereof, and a DNA probe including the other allele of which base encoded by rs2742946 is T or a DNA probe including the allele with a complementary strand thereof; (c) a set of DNA probes comprising a DNA probe including an allele of which base encoded by rs1376264 is C or a DNA probe including the allele with a complementary strand thereof, and a DNA probe including the other allele of which base encoded by rs1376264 is T or a DNA probe including the allele with a complementary strand thereof; (d) a set of DNA probes comprising a DNA probe including an allele of which base encoded by rs1126758 is C or a DNA probe including the allele with a complementary strand thereof, and a DNA probe including the other allele of which base encoded by rs1126758 is T or a DNA probe including the allele with a complementary strand thereof; and (e) a set of DAN probes comprising a DNA probe including an allele of which base encoded by rs2267437 is C or a DNA probe including the allele with a complementary strand thereof, and a DNA probe including the other allele of which base encoded by rs1126758 is G or a DNA probe including the allele with a complementary strand thereof.

Further, a method of predicting occurrence of a late adverse reaction in a urinary organ after radiotherapy using the DNA chip for predicting occurrence of a late adverse reaction in a urinary organ after radiotherapy of the present invention comprises: a first step of hybridizing the genetic marker with a labeled DNA that is prepared by labeling a DNA with a labeling substance as described above, the DNA being prepared from a subject to be examined and to be hybridized with the genetic marker; a second step of identifying bases of both alleles of the labeled DNA hybridized with the genetic marker; and a third step of determining a genotype of the labeled DNA as a risk genotype if a combination of the bases of both alleles of the labeled DNA identified in the second step is GG for rs2276015; TT or Ct for rs2742946; CC for rs1376264; TT or CT for rs1126758; or GG for rs2267437, and predicting that the subject is predisposed to develop a late adverse reaction in a urinary organ after radiotherapy when the number of the risk genotypes is three or more and the subject is not predisposed to develop a late adverse reaction in a urinary organ after radiotherapy when the number of the risk genotypes is two or less.

The DNA chip for predicting occurrence of a late adverse reaction in a urinary organ after radiotherapy of the present invention includes five risk genotype markers. Hereby, it is possible to appropriately and easily determine whether or not a patient has three or more risk genotypes, which indicate that the patient is predisposed to develop a late adverse reaction in a urinary organ after radiotherapy. Therefore, it is possible to predict whether or not the patient is predisposed to develop a late adverse reaction in a urinary organ after radiotherapy.

The method of predicting occurrence of a late adverse reaction in a urinary organ after radiotherapy of the present invention uses the DNA chip of the present invention for predicting occurrence of a late adverse reaction in a urinary organ after radiotherapy. Hereby, it is possible to appropriately and easily determine whether or not a patient has three or more risk genotypes, which indicate that the patient is predisposed to develop a late adverse reaction in a urinary organ after radiotherapy. Therefore, it is possible to predict whether or not the patient is predisposed to develop a late adverse reaction in a urinary organ after radiotherapy.

### BRIEF DESCRIPTION OF THE DRAWINGS

FIG. 1 is a graph showing ROC (receiver operating characteristic) curves in combinations of five genetic markers (SART1, ID3, EPDR1, PAH, and XRCC6) in a training set (n=132) indicated by a solid line and in a test set (n=65) indicated by a dashed line.

FIG. 2 is a histogram showing a frequency distribution per the number of risk genotypes.

### DETAILED DESCRIPTION OF THE PREFERRED EMBODIMENT

If there is no specific explanation on handling of a DNA and other necessary operations in the embodiment and example of the present invention, procedures described in a typical collection of protocols (for example, J. Sambrook, E. F. Fritsch & T. Maniatis (Ed.), Molecular cloning, a laboratory manual (3rd edition), Cold Spring Harbor Press, Cold Spring Harbor, N.Y. (2001), and F. M. Ausubel, R. Brent, R. E. Kingston, D. D. Moore, J. G Seidman, J. A. Smith, K. Struhl (Ed.), Current Protocols in Molecular Biology, John Wiley & Sons Ltd.), modified or altered procedures thereof can be applied. Moreover, when a commercially-available reagent kit or a measurement device is used, accompanying protocols can be used if there is no specific explanation. Furthermore, those skilled in the art can easily reproduce the present invention based on the descriptions in the specification of the present invention and the descriptions in the above mentioned typical collection of protocols.

Hereinafter, a DNA chip for predicting occurrence of a late adverse reaction in a urinary organ after radiotherapy of the present invention, and a method of predicting occurrence of a late adverse reaction in a urinary organ after radiotherapy using the same will be explained in detail.

First, a DNA chip for predicting occurrence of a late adverse reaction in a urinary organ after radiotherapy of the present invention (hereinafter, simply referred to a “DNA chip”) will be explained.

Herein, the adverse reaction in a urinary organ includes, for example, dysuria.

The DNA chip of the present invention is a DNA chip for predicting occurrence of a late adverse reaction in a urinary organ after radiotherapy. The radiotherapy includes heavy particle radiotherapy such as carbon ion radiotherapy (C-ion RT). Here, the radiotherapy is not limited to the above mentioned examples, and can include radiotherapy using photon beams and electron beams (hereinafter, simply referred to “photon RT”) or the like.

A radiation dose of such radiotherapy can be set to, for example, 66.0 GyE, and a patient can be irradiated with radiation separately in multiple times (e.g., 20 fractions within five weeks) as needed.

The DNA chip of the present invention comprises a supporting means for supporting a DNA probe thereon, and a plurality of genetic markers supported on the supporting means.

The supporting means may be a substrate which can fixedly hold the DNA probe, including a glass substrate and a plastic substrate.

A plurality of genetic markers include sets of DNA probes defined in the following descriptions (a) to (e). When the sets of the DNA probes are supported in the DNA chip, DNA chains (polynucleotide) with 20 to 80 bases including a base encoded by the following rs SNP ID may be used. Those DNA probes can be supported on the supporting means in a so-called Affimetrix manner utilizing photo lithography and a solid phase reaction chemical technology, or a so-called Stanford manner that a DNA piece prepared beforehand is quantitatively implanted into a preset position at a size of 10 μL to several hundred μL using a spotter.

(a) A set of DNA probes comprising a DNA probe including an allele of which base encoded by rs2276105 is G or a DNA probe including the allele with a complementary strand thereof, and a DNA probe including the other allele of which base encoded by rs2276015 is A or a DNA probe including the allele with a complementary strand thereof.

(b) A set of DNA probes comprising a DNA probe including an allele of which base encoded by rs2742946 is C or a DNA probe including the allele with a complementary strand thereof, and a DNA probe including the other allele of which base encoded by rs2742946 is T or a DNA probe including the allele with a complementary strand thereof.

(c) A set of DNA probes comprising a DNA probe including an allele of which base encoded by rs1376264 is C or a DNA probe including the allele with a complementary strand thereof, and a DNA probe including the other allele of which base encoded by rs1376264 is T or a DNA probe including the allele with a complementary strand thereof.

(d) A set of DNA probes comprising a DNA probe including an allele of which base encoded by rs1126758 is C or a DNA probe including the allele with a complementary strand thereof, and a DNA probe including the other allele of which base encoded by rs1126758 is T or a DNA probe including the allele with a complementary strand thereof.

(e) A set of DAN probes comprising a DNA probe including an allele of which base encoded by rs2267437 is C or a DNA probe including the allele with a complementary strand thereof, and a DNA probe including the other allele of which base encoded by rs1126758 is G or a DNA probe including the allele with a complementary strand thereof.

Herein, rs2276015 is an SNP positioned in an SART1 gene (chromosome 11) or in an area peripheral thereto; rs2742946 is an SNP positioned in an ID3 gene (chromosome 1) or in an area peripheral thereto; rs1376264 is an SNP positioned in an ERPD1 gene (chromosome 7) or in an area peripheral thereto; rs1126758 is an SNP positioned in a PAH gene (chromosome 12) or in an area peripheral thereto; and rs2267437 is an SNP positioned in an XRCC6 gene (chromosome 22) or in an area peripheral thereto.

It is necessary to include all sets of the DNA probes defined in the descriptions (a) to (e) in order to predict occurrence of a late adverse reaction in a urinary organ after radiotherapy. It is not desirable that the number of sets of the DNA probes defined in the descriptions (a) to (e) is four or less because statistical uncertainty increases.

The sets of the DNA probes defined in the descriptions (a) to (e) were determined by studying patients developed a late adverse reaction in a urinary organ after C-ion RT on the basis of 118 candidate genes (Suga T, Ishikawa A, Kohda M, et al. “Haplotype-based analysis of genes associated with risk of adverse skin reaction after radiotherapy in breast cancer patients”, Int J Radiat Oncol Biol Phys, 2007, 69, p 685 to 693). The 118 candidate genes were mainly identified through the inventors' comprehensive gene expression analyses of human cell lines with highly variable in vitro radiosensitivity (Ishikawa K, Koyama-Saegusa K, Otsuka Y, et al. “Gene expression profile changes correlating with radioresistance in human cell lines”, Int J Radiat Oncol Biol Phys, 2006, 65, p 234 to 245; Ban S, Ishikawa K, Kawai S, et al. “Potential in a single cancer cell to produce heterogeneous morphology, radiosensitivity and gene expression”, J Radiat Res (Tokyo), 2005, 46, p 43 to 50), and of mouse strains with different radiosensitivities (Iwakawa M, Noda S, Ohta T, et al. “Different radiation susceptibility among five strains of mice detected by a skin reaction”, J Radiat Res (Tokyo), 2003, 44, p 7 to 13; Ohta T, Iwakawa M, Oohira C, et al. “Fractionated irradiation augments inter-strain variation of skin reactions among three strains of mice”, J Radiat Res (Tokyo), 2004, 45, p 515 to 519; Iwakawa M, Noda S, Ohta T, et al. “Strain dependent differences in a histological study of CD44 and collagen fibers with an expression analysis of inflammatory response-related genes in irradiated murine lung”, J Radiat Res (Tokyo), 2004, 45, p 423 to 433; Noda S, Iwakawa M, Ohta T, et al. “Inter-strain variance in late phase of erythematous reaction or leg contracture after local irradiation among three strains of mice”, Cancer Detect Prey, 2005, 29, p 376 to 382).

Candidate genes were also isolated from other scientific reports on radiation sensitivity (see Supplementary Table in Suga et al. (Suga T, Ishikawa A, Kohda M, et al. “Haplotype-based analysis of genes associated with risk of adverse skin reactions after radiotherapy in breast cancer patients”, hit J Radiat Oncol Biol Phys, 2007, 69, p 685 to 693)).

Those candidate genes can be evaluated, for example, by dividing PCa patients who had undergone C-ion RT into a training set (or a group) for confirming an association between an SNP genotype and an adverse reaction in a urinary organ and combined effects of genetic variation on the risk of the adverse reaction in a urinary, and a test set (or a group) for confirming a result acquired from the training set. Subsequently, the evaluation is conducted by further dividing the groups into a control group (Grade 0 (no occurrence of a late adverse reaction in a urinary organ)) and a case group (Grade 1 (minor occurrence of a late adverse reaction in a urinary organ)). Here, the rate between the training set and the test set can be set to, for example, 2:1.

The association between an SNP genotype and occurrence of an adverse reaction in a urinary organ can be evaluated by utilizing, for example, Fisher's exact test. According to Fisher's exact test, it is possible to verify whether or not there is a statistically-significant association in a genotype frequency between a patient who develops an adverse reaction and a patient who does not develop such an adverse reaction. Herein, the evaluation technique for the association between an SNP genotype and occurrence of an adverse reaction in a urinary organ is not limited to Fisher's exact test. For example, when the number of samples is sufficiently large, chi-square test or the like can be applied.

Moreover, in order to confirm combined effects of genetic variation on the risk of the adverse reaction in a urinary organ, and to evaluate the association between an SNP genotype and the adverse reaction in a urinary organ, AUC-ROC (an area below an RCO curve line) curve analysis is applied. The analysis is preferable because it is possible to simultaneously evaluate a sensitivity of a marker and a false positive rate. Here, the confirmation technique of combined effects of genetic variation on the risk of the adverse reaction in a urinary organ is not limited to the AUC-ROC curve analysis.

So far, there is no method of predicting an adverse reaction in a urinary organ. In the present invention, an SNP (or a combination of SNPs) showing an AUC value of more than 0.5 calculated by the AUC-ROC curve analysis, and more preferably, an SNP (or a combination of SNPs) showing an AUC value of 0.77 and more are defined as “risk genotypes”. Here, an AUC value of 0.5 means that a prediction rate of occurrence of an adverse reaction is 50%.

For the analyses of the risk genotypes, any kind of genotyping systems can be used. For example, the analyses can be carried out by a genotyping procedure using the MassARRAY system. The genotyping procedure using the MassARRAY system is disclosed in, for example, Suga T, Ishikawa A, Kohda M, et al. “Haplotype-based analysis of genes associated with risk of adverse skin reactions after radiotherapy in breast cancer patients”, Int J Radiat Oncol Biol Phys, 2007, 69, p 685 to 693.

An association between a statistical significance and a grade of dysuria and genotyping results of SNPs of PCa patients can be evaluated by, for example, Fisher's exact test.

Moreover, the statistical analyses can be carried out by using, for example, the SNPAlyze software (version 6.0, http://www.dynacom.co.ip/e/products/package/snpalyze/index.html; Dynacom, Chiba prefecture, Japan).

Next, a method of predicting occurrence of a late adverse reaction in a urinary organ after radiotherapy (hereinafter, simply referred to a “predicting method”) of the present invention will be explained.

The predicting method of the present invention is a method using the DNA chip of the present invention. The predicting method of the present invention comprises first to third steps as mentioned below.

The first step is a step of hybridizing a plurality of genetic markers supported on the DNA chip of the present invention (i.e., sets of DNA probes defined in the descriptions (a) to (e)) with a labeled DNA that is prepared by labeling a DNA (polynucleotide) with a labeling substance. Herein, the DNA (polynucleotide) is prepared from a subject to be determined and is to be hybridized with the genetic markers.

The DNA prepared from a subject to be determined is a genomic DNA collected from, for example, a whole blood or an arbitrary cell strain of a PCa patient who is a subject to be determined.

The genomic DNA can be easily extracted from a whole blood by using, for example, an automatic nucleic acid isolation system like NA3000S made by Kurabo industries Ltd., or a commercially-available extraction kit like QIAamp DNA blood kit (Qiagen GmbH, Hilden, Germany).

A DNA concentration can be also determined by using a commercially-available reagent like PicoGreen reagent.

A DNA to be hybridized with the genetic marker can be obtained by selectively amplifying a DNA having a complementary base sequence to the genetic marker through, for example, a PCR (polymerase chain reaction) method using a sense primer and an anti-sense primer both designed arbitrary and an extracted genomic DNA to be a template.

Herein, it is preferable that such a DNA may include, for example, about 100 to 200 bases so as to appropriately facilitate the hybridization with the genetic marker.

Further, a sense primer and an anti-sense primer can be prepared as needed.

As a labeling substance, a fluorochrome which is easily detected by a DNA micro array system can be used. The fluorochrome includes, for example, conventionally well-known Cy3 and Cy5. Moreover, a radioactive substance can be used as a labeling substance. Furthermore, visible detection can be realized when biotin is used as a labeling substance.

As mentioned above, the labeled DNA to be hybridized with the genetic marker can be prepared accordingly.

The labeled DNA has a complementary base sequence to the genetic marker as explained above, and thus can be hybridized with the genetic marker.

Hybridization of the genetic marker with the labeled DNA varies depending on the length (number) of the base sequence, the rate of TGC presence, and the like. Therefore, it is desirable to set hybridization conditions accordingly. For example, the hybridization can be carried out at 42 to 60° C. in a solution of 1M NaCl, when the base sequence has 100 to 200 bases in length.

It is needless to say that the first step includes a step of rinsing a DNA remaining unhybridized and a DNA with insufficient hybridization intensity through an ordinary rinsing method. The rinsing can be carried out at a room temperature to 60° C. in a solution of 0.3 M NaCl.

The second step is a step of determining a genotype of the labeled DNA hybridized with the genetic marker. For example, labeling with biotin enables a visible determination. Moreover, labeling with a flurochrome enables a measurement through a conventionally-well-known DNA array scanner.

The third step is a step of determining the genotype of the labeled DNA as a risk genotype, if a combination of bases of both alleles of the labeled DNA identified in the second step is GG for rs2276015, TT or CT for rs2742946, CC for rs1376264, TT or CT for rs1126758, or GG for rs2267437, and predicting that the subject is predisposed to develop a late adverse reaction in a urinary organ after radiotherapy when the number of the risk genotypes is three or more and the subject is not predisposed to develop a late adverse reaction in a urinary organ after radiotherapy when the number of the risk genotypes is two or less.

Hereby, the combination of the risk genotypes is definitely determined by the study of the present inventors.

### EXAMPLES

### 1. Methods and Materials

197 patients included in this study were participants in the clinical studies of C-ion RT for PCa at the National Institute of Radiological Sciences (Chiba, Japan). All patients and 227 healthy donors provided written informed consent to participate in the study. The Ethical Committee at the National Institute of Radiological Sciences approved the study. All identifying information was managed at the Medical Information Processing Office of the Research Center Hospital for Charged Particle Therapy of the National Institute of Radiological Sciences.

The first patient group (n=132) was enrolled between January 2002 and March 2006. The second patient group (n=65) was enrolled between March 2006 and December 2006.

The subjects were divided, approximately 2:1 into two sets: a training set and a test set.

In the training set, 109 subjects (86.2%) were diagnosed with Grade 0 dysuria. 23 subjects (17.4%) had Grade 1 dysuria 3 months after RT.

In the test set, 56 subjects (86.2%) had Grade 0 dysuria. 9 subjects (13.8%) had Grade 1 or Grade 2 dysuria.

The study design, including patient eligibility, C-ion RT, and hormonal treatment, has been previously described in detail (Tsuji H, Yanagi T, Ishikawa H, et al. “Hypofractionated radiotherapy with carbon ion beams for prostate cancer”, Int J Radiat Oncol Biol Phys, 2005, 63, p 1153 to 1160, Ishikawa H, Tsuji H, Kamada T, et al. “Risk factors of late rectal bleeding after carbon ion therapy for prostate cancer”, Int J Radiat Oncol Biol Phys, 2006, 66, p 1084 to 1091).

Most of the patients were enrolled in a Phase II study and received a dose of 66.0 GyE. The dose fractionation schedule of 66.0 GyE was delivered in 20 fractions within five weeks. None of the patients had undergone previous treatment for PCa except for hormonal therapy.

Late adverse urinary reaction (dysuria) was scored using the Late Effects of Normal Tissue-Subjective, Objective, Management and Analysis scoring system (LENT SOMA tables. Radiother Oncol, 1995, 35, p 17 to 60). Emphasis was placed mainly on the “subjective” and “management” categories.

The scoring of dysuria symptoms was as follows: Grade 0, no subjective awareness compared with status before RT; Grade 1, mild (occasional and minimal) awareness with or without occasional administration of an α₁-blocker; Grade 2, moderate (intermittent and tolerable) awareness with regular administration of an α₁-blocker. The scores for late reactions were the greatest grade observed at 3 months after C-ion RT.

### 2. Candidate Genes and SNPs

The inventors' concept for selecting the candidate genes responsible for variations in radiosensitivity, a list of the candidate genes, and the genotyping procedure using the MassARRAY system (Sequenom, San Diego, Calif.) have been previously described (Suga T, Ishikawa A, Kohda M, et al. “Haplotype-based analysis of genes associated with risk of adverse skin reactions after radiotherapy in breast cancer patients” Int J Radiat Oncol Biol Phys, 2007, 69, p 685 to 693).

In this study of PCa patients, 450 SNPs at 118 loci were subjected to genetic analysis.

Extraction of genomic DNA from whole blood was performed with an automatic nucleic acid isolation system (NA-3000S, Kurabo, Osaka, Japan) or with a QIAamp DNA blood kit (Qiagen, Hilden, Germany).

The DNA concentration was measured using the PicoGreen reagent (Singer V L, Jones L J, Yue S T, et al. “Characterization of PicoGreen reagent and development of a fluorescence-based solution assay for double-stranded DNA quantitation” Anal Biochem, 1997, 249, p 228 to 238).

The primer sequences used for genotyping were prepared as needed.

### 3. Statistical Analysis

The allele and genotype frequencies for each polymorphism were calculated. The Hardy-Weinberg equilibrium was evaluated using the chi-square test among healthy donors and the whole PCa patient group.

Statistical significance and the strength of associations between dysuria grades and each of the SNPs in the PCa patients were assessed using the two-tailed Fisher's exact test and odds ratios, respectively.

These statistical analyses were performed using SNPAlyze software (version 6.0, http://www.dynacom.co.ip/e/products/package/snpalyze/index.html; Dynacom, Chiba, Japan).

To select the appropriate SNP markers associated with the risk of dysuria using the training set, the sensitivity and specificity of the markers were evaluated using AUC-ROC curve analysis (Hanley J A, McNeil B J. “The meaning and use of the area under a receiver operating characteristics (ROC) curve”, Radiology, 1982, 143, p 29 to 36).

The forward selection procedures of the marker contributing to an AUC-ROC value were as follows:

(1) Assume K significant SNPs identified.

(2) Define K indicator variables xₖ (k=1, . . . K).

(3) Set PS₁=xₖ in such a way that xₖ has the largest averaged AUC-ROC in {(xᵢ, . . . , xₖ}.

(4) Redefine xₖ (k=1, . . . , K−1) excluding a variable selected as PS₁.

(5) Set PS₂=PS₁+xₖ in such a way that PS₁+xₖ has the largest averaged AUC-ROC in {PS₁+xₖ, . . . , PS₁+x_{k-1}}

(6) Redefine xₖ (k=1, . . . , K−2), and repeat in the same manner.

The ability of the selected marker set to predict the susceptibility to dysuria was evaluated further with AUC-ROC curve analysis using the test set.

### 4. Results

A total of 450 SNPs at 118 loci were selected as candidates for conferring variations in radiosensitivity in PCa patients and were subjected to additional genetic analysis. As a result, of the 450 SNPs, 12 were not polymorphic in the current PCa patient group. In addition, 27 SNPs were excluded from this association study because of their low allele frequency (minor allele frequency, <5%). Nine SNPs were not analyzed further, because they were not in agreement with the Hardy-Weinberg equilibrium in the group of healthy donors (p<0.001). Moreover, 29 SNPs were removed from additional analysis because the genotypes of these SNPs were identical to those of the respective contiguous SNPs.

Accordingly, only 373 SNPs at 109 loci were analyzed further.

The positional properties of these SNPs are listed in Table 1.

TABLE 1

| Position | n | (%) |
|---|---|---|
| 5′-Flanking | 87 | (23.3) |
| 5′-UTR | 4 | (1.1) |
| cSNP | 30 | (8.0) |
| sSNP | 23 | (6.2) |
| iSNP | 138 | (37.0) |
| 3′-UTR | 20 | (5.4) |
| 3′-Flanking | 71 | (19.0) |
| Total | 373 | (100) |

Abbreviations in table 1: SNP is a single nucleotide polymorphism, UTR is an untranslated region, cSNP is a nonsynonymous SNP, sSNP is a synonymous SNP, and iSNP is an intron SNP.

The clinical features of the case patients (Grade 1 or greater) and the control patients (Grade 0) in the training set are listed in Table 2.

TABLE 2

| | Grade 0 | | Grade 1 + | | |
|---|---|---|---|---|---|
| Characteristic | (n = 109) | | (n = 23) | | p |
| Age during RT (y) | | | | | |
| Mean ± SD | 69 ± 5 | | 68 ± 6 | | |
| Range | 56-87 | | 54-77 | | 0.39^{†} |
| Smoking habit | | | | | |
| Yes | 17 | (15.6) | 2 | (8.7) | 0.60* |
| Quit | 36 | (33.0) | 10 | (43.5) | |
| Never | 56 | (51.4) | 11 | (47.8) | |
| Hormonal therapy | 72 | (66.1) | 17 | (73.9) | 0.63* |
| T stage^{‡} | | | | | 0.87* |
| T1 | 31 | (28.4) | 6 | (26.1) | |
| T2 | 35 | (32.1) | 9 | (39.1) | |
| T3 | 42 | (38.5) | 8 | (34.8) | |
| T4 | 1 | (0.9) | 0 | (0.0) | |
| Radiation dose (GyE)^{‡} | | | | | |
| 57.6 | 2 | (1.8) | 1 | (4.3) | 0.33* |
| 60.0 | 3 | (2.8) | 0 | (0.0) | |
| 63.0 | 3 | (2.8) | 0 | (0.0) | |
| 66.0 | 101 | (92.7) | 21 | (91.3) | |
| 72.0 | 0 | (0.0) | 1 | (4.3) | |

Distribution of patients with dysuria was 109 with Grade 0 and 23 with Grade 1.
Data in parentheses are percentages.
*indicates a statistical significance between two groups analyzed with Fisher's exact test.
^{†}indicates an unpaired t test.
^{‡}indicates that not all percentages sum become to 100% because of rounding.

The SNPs at 14 loci were associated with dysuria according to an allele type or a genotype (either a dominant or a recessive model (see Table 3)).

TABLE 3

| | | | | Allele | | | | Genotype |
|---|---|---|---|---|---|---|---|---|
| | | | SNP | Grade 0 | Grade 1 | | | Grade 0 |
| Gene | rsSNP ID | Chr | Mm | M/m | M/m | p | OR (95% CI) | MM/Mm/mm |
| ALAD | rs1805312 | 9 | CG | 192/26 | 35/11 | 0.058 | 2.32 (1.05-5.12) | 83/26/0 |
| CD68 | rs2270341 | 17 | TA | 145/73 | 25/21 | 0.13 | 0.59 (0.31-1.14) | 46/53/10 |
| XRCC6 | rs2267437 | 22 | CG | 148/70 | 25/21 | 0.089 | 1.77 (0.93-3.38) | 48/52/9 |
| ID3 | rs2742946 | 1 | CT | 127/91 | 21/25 | 0.14 | 1.66 (0.87-3.14) | 48/52/9 |
| LIG1 | rs1171097 | 19 | CG | 178/40 | 31/15 | 0.044 | 2.15 (1.06-4.35) | 73/32/4 |
| LIG3 | rs3744357 | 17 | CT | 188/30 | 33/13 | 0.026 | 2.46 (1.16-5.21) | 80/28/1 |
| MAP3K7 | rs1475489 | 6 | AT | 158/60 | 24/20 | 0.030 | 2.19 (1.13-4.26) | 56/46/7 |
| MGMT | rs1803965 | 10 | CT | 184/34 | 45/1 | 0.015 | 0.12 (0.01-0.90) | 79/26/4 |
| PAH | rs1126758 | 12 | CT | 205/13 | 39/7 | 0.058 | 2.83 (1.06-7.54) | 96/13/0 |
| PER3 | rs228697 | 1 | CG | 204/14 | 38/8 | 0.034 | 3.06 (1.20-7.81) | 95/14/0 |
| SART1 | rs2276015 | 11 | GA | 172/46 | 44/2 | 0.0056 | 0.17 (0.03-0.72) | 70/32/7 |
| SERPINA3 | rs2268337 | 14 | AG | 163/55 | 42/4 | 0.018 | 0.28 (0.09-0.82) | 61/41/7 |
| TGFBR1 | rs868 | 9 | AG | 201/17 | 46/0 | 0.050 | NC | 94/13/2 |
| EPDR1 | rs1376264 | 7 | CT | 168/50 | 42/4 | 0.028 | 0.32 (0.10-0.93) | 61/46/2 |

| | Genotype | | | | |
|---|---|---|---|---|---|
| | Grade 1 | Dominant model | | Recessive model | |
| Gene | MM/Mm/mm | p | OR (95% CI) | p | OR (95% CI) |
| ALAD | 14/7/2 | 0.029 | NC | 0.19 | 2.05 (0.79-5.28) |
| CD68 | 8/9/6 | 0.035 | 3.49 (1.12-10.8) | 0.64 | 1.36 (0.53-3.49) |
| XRCC6 | 8/9/6 | 0.025 | 3.92 (1.23-12.4) | 0.49 | 1.47 (0.57-3.76) |
| ID3 | 2/17/4 | 0.76 | 1.13 (0.34-3.76) | 0.023 | 4.96 (1.10-22.3) |
| LIG1 | 11/9/3 | 0.10 | 3.93 (0.81-18.9) | 0.098 | 2.21 (0.89-5.49) |
| LIG3 | 12/9/2 | 0.078 | 10.2 (0.89-118.) | 0.078 | 2.52 (1.00-6.35) |
| MAP3K7 | 6/12/4 | 0.089 | 3.23 (0.85-12.2) | 0.060 | 2.81 (1.02-7.74) |
| MGMT | 22/1/0 | 1.0 | NC | 0.015 | 0.11 (0.01-0.92) |
| PAH | 16/7/0 | NC | NC | 0.048 | 3.23 (1.11-9.32) |
| PER3 | 15/8/0 | NC | NC | 0.026 | 3.61 (1.29-10.0) |
| SART1 | 21/2/0 | 0.61 | NC | 0.012 | 0.17 (0.03-0.76) |
| SERPINA3 | 19/4/0 | 0.61 | NC | 0.019 | 0.26 (0.08-0.83) |
| TGFBR1 | 23/0/0 | 1.0 | NC | 0.072 | NC |
| EPDR1 | 19/4/0 | 1.0 | NC | 0.019 | 0.26 (0.08-0.83) |

Abbreviations in Table 3: SNP is a single nucleotide polymorphism, ID is an identification, Chr is a chromosome, M is a major allele, m is a minor allele, NC indicates no calculation (insufficient sample size to perform calculation). Moreover, p is a p value (significance probability), OR is an odds ratio, and CI is a confidence interval.

Here in Table 3, a statistical significance is shown between two groups analyzed through Fisher's exact test.

As shown in Table 3, results of the genotyping data collected indicate that bases of a major allele of rs2276015 (SART1) and a minor allele thereof are G and C, respectively, bases of a major allele of rs2742946 and a minor allele thereof are C and T, respectively, bases of a major allele of rs1376264 (EPDR1) and a minor allele thereof are C and T, respectively, bases of a major allele of rs1126758 (PAH) and a minor allele thereof are C and T, respectively, and bases of a major allele of rs2267437 (XRCC6) and a minor allele thereof are C and G respectively.

The SNP markers that distinguished patients susceptible to developing dysuria from those not at risk were isolated by a stepwise forward selection procedure using AUC-ROC curve analysis. The marker that increased the area under the ROC curve the most was selected step by step.

The markers selected using this method were rs2276105 (SART1), rs2742946 (ID3), rs1376264 (EPDR1), rs1126758 (PAH), and rs2267437 (XRCC6) polymorphisms.

The AUC-ROC curve reached 0.86 using these five markers (see Table 4).

TABLE 4

| SNPs combination | AUC-ROC |
|---|---|
| rs2276015 | 0.635 |
| rs2276015 + rs2742946 | 0.718 |
| rs2276015 + rs2742946 + rs1376264 | 0.776 |
| rs2276015 + rs2742946 + rs1376264 + | 0.825 |
| rs1126758 | |
| rs2276015 + rs2742946 + rs1376264 + | 0.861 |
| rs1126758 + rs2267437 | |

Abbreviations in Table 4: SNP is a single nucleotide polymorphism, AUC-ROC is an area under curve of receiver operating characteristic.

As shown in Table 3 and Table 4, results generated by a statistical method indicate that when a combination of bases of both alleles is GG for rs2276015 (SART1), TT and CT for rs2742946 (ID3), CC for rs1376264 (EPDR1), TT and CT for rs1126758 (PAH), or GG for rs2267437 (XRCC6), a genotype having the combination can be determined as a risk genotype.

To test the effectiveness of these genetic markers in predicting the risk of dysuria, the markers were further analyzed in the test set.

Table 5 lists the patient characteristics and treatment details of the patients in the test set.

TABLE 5

| | Grade 0 | | Grade 1 + | | |
|---|---|---|---|---|---|
| Characteristic | (n = 56) | | (n = 9) | | p |
| Age at RT (y) | | | | | |
| Mean ± SD | 68 ± 6 | | 68 ± 7 | | |
| Range | 51-80 | | 52-79 | | 0.99^{†} |
| Smoking habit | | | | | |
| Yes | 7 | (12.5) | 0 | (0.0) | 0.76* |
| Quit | 16 | (28.6) | 3 | (33.3) | |
| Never | 31 | (55.4) | 6 | (66.7) | |
| Unknown | 2 | (3.6) | 0 | (0.0) | |
| Hormonal therapy | 47 | (83.9) | 6 | (66.7) | 0.35* |
| T stage^{‡} | | | | | 0.70* |
| T1 | 9 | (16.1) | 2 | (22.2) | |
| T2 | 31 | (55.4) | 4 | (44.4) | |
| T3 | 16 | (28.6) | 3 | (33.3) | |
| Radiation dose (GyE) | | | | | |
| 57.6 | 15 | (26.8) | 1 | (11.1) | 0.25* |
| 63.0 | 37 | (66.1) | 6 | (66.7) | |
| 66.0 | 4 | (7.1) | 2 | (22.2) | |

Distribution of patients with dysuria was 56 with Grade 0, 5 with Grade 1, and 4 5 with Grade 2.
*indicates a statistical significance between two groups analyzed with Fisher's exact test.
^{†}indicates an unpaired t test.
^{‡}indicates that not all percentages sum become to 100% because of rounding.

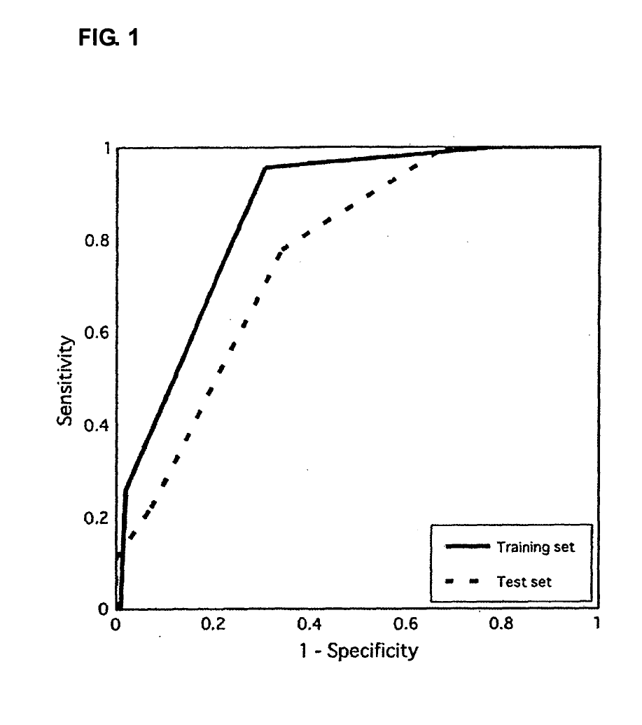

The test set included 4 subjects with Grade 2 dysuria. No statistically significant differences were observed between the case and control patients in any of the features. The AUC-ROC curve value of the model consisting of the five selected markers reached a value of 0.77, indicating that these five markers had a significant association with an increased risk of dysuria (see FIG. 1). Here, FIG. 1 is a graph showing an ROC (receiver operating characteristic) in combinations of five genetic markers (SART1, ID3, EPDR1, PAH, and XRCC6) in the training set (n=132) indicated by a solid line and in the test set (n=65) indicated by a dashed line. The horizontal axis in the figure indicates 1-Specificity (specificity), and the vertical axis indicates Sensitivity (sensitivity).

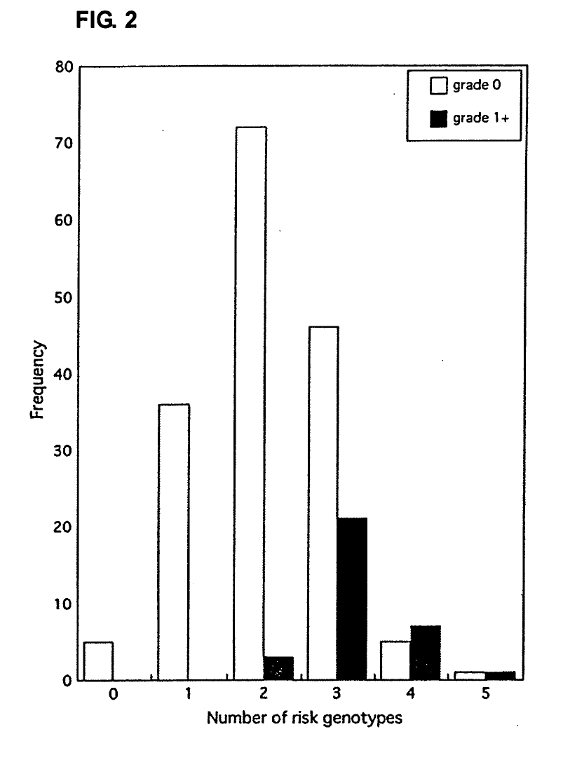

The number of patients per risk genotype is shown in FIG. 2. FIG. 2 is a histogram showing a frequency distribution per the number of risk genotypes. FIG. 2 shows Grade 0 dysuria of a total of 165 patients (white bar), and Grade 1 or greater dysuria of 32 patients (black bar).

Among the 32 patients with dysuria, 29 (90.6%) patients had more than three risk genotypes.

However, 52 patients (31.5%) without dysuria also had more than three risk genotypes.

### 5. Discussion

In the present embodiment, five new genetic markers that can be used to stratify the risk of developing dysuria after C-ion RT in PCa patients are identified. These markers are chosen from 450 SNPs in 118 candidate genes, which are mainly selected on the basis of the inventors' previous comprehensive gene expression analysis (Suga T, Ishikawa A, Kohda M, et al. “Haplotype-based analysis of genes associated with risk of adverse skin reactions after radiotherapy in breast cancer patients”, Int J Radiat Oncol Biol Phys, 2007, 69, p 685 to 693, Ishikawa K, Koyama-Saegusa K, Otsuka Y, et al. “Gene expression profile changes correlating with radioresistance in human cell lines”, Int J Radiat Oncol Biol Phys, 2006, 65, p 234 to 245, Ban S, Ishikawa K, Kawai S, et al. “Potential in a single cancer cell to produce heterogeneous morphology, radiosensitivity and gene expression”, J Radiat Res (Tokyo), 2005, 46, p 43 to 50, Iwakawa M, Noda S, Ohta T, et al. “Different radiation susceptibility among five strains of mice detected by a skin reaction”, J Radiat Res (Tokyo), 2003, 44, p 7 to 13, Ohta T, Iwakawa M, Oohira C, et al. “Fractionated irradiation augments inter-strain variation of skin reactions among three strains of mice”, J Radiat Res (Tokyo), 2004, 45, p 515 to 519, Iwakawa M, Noda S, Ohta T, et al. “Strain dependent differences in a histological study of CD44 and collagen fibers with an expression analysis of inflammatory response-related genes in irradiated murine lung”, J Radiat Res (Tokyo), 2004, 45, p 423 to 433, Noda S, Iwakawa M, Ohta T, et al. “Inter-strain variance in late phase of erythematous reaction or leg contracture after local irradiation among three strains of mice”, Cancer Detect Prey, 2005, 29, p 376 to 382).

In the present embodiment, predictive scores are constructed by the accumulated number of risk alleles to maximize the AUC-ROC curve to gain better sensitivity and better specificity with high discriminating power. The ability of the selected marker set to predict for susceptibility to dysuria is confirmed in the test set of case and control patients.

Therefore, these results indicate that combinations of these genetic variations at multiple loci could possibly determine the complexity of an individual's radiosensitivity.

Because Andreassen et al. established a simplistic putative model for the estimation of mammary fibrosis risk using multiple SNPs (Andreassen C A, Alsner J, Overgaard M, et al. “Prediction of normal tissue radiosensitivity from polymorphisms in candidate genes”, Radiother Oncol, 2003, 69, p 127 to 135), the inventors of the present invention use the total number of risk alleles as a parameter for the estimation of dysuria risk.

All the PCa patients included in this study had undergone C-ion RT at the same hospital. Dysuria can occur as a late normal tissue injury after RT, and it might be a symptom of a complex and multifactorial disease.

Dysuria usually develops as a consequence of chronic urethral inflammation or stenosis. One advantage of analyzing a group of patients from a single hospital is that nongenetic risk factors, such as variations in therapeutic protocols and possible scoring differences between examiners from multiple institutions, could not compound the results (this consideration arose during the inventors' previous statistical analysis of breast cancer patients from multiple institutions (Iwakawa M, Noda S, Yamada S, et al. “Analysis of non-genetic risk factors for adverse skin reactions to radiotherapy among 284 breast cancer patients”, Breast Cancer, 2006, 13, p 300 to 307)). Although the sample size of the study was small, it is demonstrated that clinical factors could not be associated statistically with dysuria (see Tables 2 and 5).

The SNPs that are finally selected are located in, or flanking, the following genes: SART1, ID3, EPDR1, PAH, and XRCC6.

Three of these (SART1, ID3, and XRCC6) encode nuclear proteins.

SART1 functions as a splicing catalyst of tri-snRNP and in tumor-specific immunity (Shichijo S, Nakao M, Imai Y, et al. “A gene encoding antigenetic peptides of human squamous cell carcinoma recognized by cytotoxic T lymphoctytes”, J Exp Med, 1998, 187, p 277 to 288; Kawamoto M, Shichijo S, Imai Y, et al. “Expression of the SART-1 tumor rejection antigen in breast cancer”, Int J Cancer, 1999, 80, p 64 to 67; Makarova O V, Makarov E M, Luhrmann R, “The 65 and 1101kDa SR-related proteins of the U4/U6.U5 tri-snRNP are essential for the assembly of mature spliceosomes”, EMBO J, 2001, 20, p 2553 to 2563).

ID3 (inhibitor of DNA binding 3) negatively regulates cell differentiation by inhibiting DNA binding of certain basic helix-loop-helix transcription factors (Deed R W, Bianchi S M, Atherton G T, et al. “An immediate early human gene encodes an Id-like helix-loop-helix protein and is regulated by protein kinase C activation in diverse cell types”, Oncogene, 1993, 8, p 599 to 607).

XRCC6 (X-ray repair complementing defective repair in Chinese hamster cells 6) is known as KU70 and acts as a DNA helicase II subunit, involved in DNA repair, apoptosis, and drug resistance (Reeves W H, Sthoeger Z M, “Molecular cloning of cDNA encoding the p70 (Ku) lupus autoantigen”, J Biol Chem, 1989, 264, p 5047 to 5052; Chan J Y, Lerman M I, Prabhakar B S, et al. “Cloning and characterization of a cDNA that encodes a 70-kDa novel human thyroid autoantigen”, J Biol Chem, 1989, 264, p 3651 to 3654; Tuteja N, Tuteja R, Ochem A, et al. “Human DNA helicase II: A novel DNA unwinding enzyme identified as the Ku autoantigen”, EMBO J, 1994, 13, p 4991 to 5001; Gu Y, Jin S, Gao Y, et al. “Ku70-deficient embryonic stem cells have increased ionizing radiosensitivity, defective DNA endbinding activity, and inability to support V(D)J recombination”, Proc Natl Acad Sci USA, 1997, 94, p 8076 to 8081).

EPDR1 is a putative type II transmembrase calcium-dependent cell adhesion molecule (Nimmrich I, Erdmann S, Melchers U, et al. “The novel ependymin related gene UCC1 is highly expressed in colorectal tumor cells”, Cancer Lett, 2001, 165, p 71 to 79; Gregotio-King C C, McLeod J L, Collier F M, et al. “MERP1: a mammalian epenymin-related protein gene differentially expressed in hematopoietic cells”, Gene, 2002, 286, p 249 to 257).

PAH (phenylalanine hydroxylase) encodes a cytosolic protein that converts phenylalanine to tyrosine (Woo S L, Lidsky A S, Guttler F, et al. “Cloned hu phenylalanine hydroxylase gene allows prenatal diagnosis and carrier detection of classical phenylketonuria”, Nature, 1983, 306, p 151 to 155).

So far, the functions of the gene products associated with radiosensitivity are not known well, except for XRCC6. Moreover, it is possible that the SNP markers identified in the present embodiment work only as surrogate markers.

However, four of the genes selected for this study (SART1, ID3, PAH, and XRCC6) are identified in the comprehensive gene expression analysis of human cell lines with highly variable radiosensitivity in vitro (Ishikawa K, Koyama-Saegusa K, Otsuka Y, et al. “Gene expression profile changes correlating with radioresistance in human cell lines”, Int J Radiat Oncol Biol Phys, 2006, 65, p 234 to 245). Transcription of these genes tends to be greater in radioresistant cell lines and lower in relatively radiosensitive cell lines. It is strongly suggested that the variations in transcriptional activity of these genes can cause differences in individual radiosensitivity.

Genetic variations in the ATM, TGFb1, LIG4, ERCC2, and CYP2D6*4 genes are associated with the risk of adverse urinary, bladder, rectal, or sexual response in PCa patients treated with photon RT (Cesaretti J A, Stock R G; Lehrer S, et al. “ATM sequence variations are predictive of adverse radiotherapy response among patients treated for prostate cancer”, Int J Radiat Oncol Biol Phys, 2005, 61, p 196 to 202; Peters C A, Stock R G, Cesaretti J A, et al. “TGFB1 Single nucleotide polymorphisms are associated with adverse quality of life in prostate cancer patients treated with radiotherapy”, Int J Radiat Oncol Biol Phys, 2008, 70, p 752 to 759; Damaraju S, Murray D, Dufour J, et al. “Association of DNA repair and steroid metabolism gene polymorphisms with clinical late toxicity in patients treated with conformal radiotherapy for prostate cancer”, Clin Cancer Res, 2006, 12, p 2545 to 2554).

Among these genes, one SNP in TGFb1 and five SNPs in ATM were included in the inventors' study. However, rs1800469 (C-509T) in TGFb1 was not associated with the risk of dysuria (p=0.67).

Moreover, the five ATM SNPs, rs1800057, rs1801516, rs1801673, rs2234997, and rs3218673 were not polymorphic in the present embodiment.

Furthermore, it is important to determine whether the genetic differences indicated in this study are also found in PCa patients who have undergone conventional photon RT or proton therapy in order to investigate whether the onset of adverse effects results from qualitative differences in linear energy transfer.

As shown in FIG. 2, although dysuria could be predicted in 90% of the cases, approximately 30% of the patients had false-positive results when three risk genotypes were used as the cutoff value. However, among the patients with false-positive results (i.e., the patients without dysuria 3 months after RT), 6 patients (11.5%) developed dysuria during the next 3 months. Therefore, it is possible that some patients with false-positive results at 3 months might develop adverse urinary reaction in the future.

Another possibility is that patients encoding the risk genotypes might also possess protective or reduced risk genotypes that were not detected in the present analysis.

In the present embodiment, five polymorphic markers associated with an increased risk of dysuria from the 118 candidate genes can be selected. However, it is possible that more genetic variations associated with dysuria exist in the human genome.

A larger study designed to analyze many more candidate genes for performing genome-wide association studies is necessary. Moreover, it is important to investigate a larger cohort of PCa patients undergoing RT.

### 6. CONCLUSION

According to the present invention, it is possible to identify novel SNPs associated with an increased risk of developing dysuria after C-ion RT and to define five risk genotypes. Although more patients are required to validate these results, the results as mentioned above support the assumptions that multiple loci contribute to the risk of development of an adverse urinary reaction

If it is possible to predict the risk of development of an adverse effect, understanding of an adverse effect of a patient becomes expand, the patient can have a safe medical treatment, resulting in contribution to maintaining of a high quality-of-life after treatment.

According to the present invention, it is possible to predict that PCa patients with three or more risk genotypes require particular care for the treatment of dysuria. That is, by developing a DNA chip for determining whether or not a subject to be determined has three or more risk genotypes, including GG of rs2276015 (SART1); TT and CT of rs2742946 (ID3); CC of rs1376264 (EPDR1); TT and CT of rs1126758 (PAH); and GG of rs2267437 (XRCC6), it is possible to carry out the foregoing prediction surely and easily.

According to the present invention, a DNA chip for determining whether or not a subject to be determined has three of more risk genotypes, including GG of rs2276015 (SART1); TT and CT of rs2742946 (ID3); CC of rs1376264 (EPDR1); TT and CT of rs1126758 (PAH); and GG of rs2267437 (XRCC6), is provided. By genetic analysis using the DNA chip, it is possible to predict occurrence of a late adverse reaction in a urinary organ after radiotherapy.

What is claimed is:

1. A DNA chip for predicting an occurrence of a late adverse reaction in a urinary organ after radiotherapy, the DNA chip comprising:
a supporting means for supporting a synthesized DNA probe; and
a plurality of genetic markers supported on the supporting means, wherein
the plurality of the genetic markers include:
(a) a set of DNA probes comprising a DNA probe including an allele of which base encoded by rs2276105 is G or a DNA probe including the allele with a complementary strand thereof, and a DNA probe including the other allele of which base encoded by rs2276015 is A or a DNA probe including the allele with a complementary strand thereof;
(b) a set of DNA probes comprising a DNA probe including an allele of which base encoded by rs2742946 is C or a DNA probe including the allele with a complementary strand thereof, and a DNA probe including the other allele of which base encoded by rs2742946 is T or a DNA probe including the allele with a complementary strand thereof;
(c) a set of DNA probes comprising a DNA probe including an allele of which base encoded by rs1376264 is C or a DNA probe including the allele with a complementary strand thereof, and a DNA probe including the other allele of which base encoded by rs1376264 is T or a DNA probe including the allele with a complementary strand thereof;
(d) a set of DNA probes comprising a DNA probe including an allele of which base encoded by rs1126758 is C or a DNA probe including the allele with a complementary strand thereof, and a DNA probe including the other allele of which base encoded by rs1126758 is T or a DNA probe including the allele with a complementary strand thereof; and
(e) a set of DAN probes comprising a DNA probe including an allele of which base encoded by rs2267437 is C or a DNA probe including the allele with a complementary strand thereof, and a DNA probe including the other allele of which base encoded by rs1126758 is G or a DNA probe including the allele with a complementary strand thereof.

2. A method of predicting occurrence of a late adverse reaction in a urinary organ after radiotherapy using the DNA chip for predicting occurrence of a late adverse reaction in a urinary organ after radiotherapy according to claim 1, the method comprising:
a first step of hybridizing the genetic marker with a labeled DNA that is prepared by labeling a DNA with a labeling substance, the DNA being prepared from a subject to be examined and to be hybridized with the genetic marker;
a second step of identifying bases of both alleles of the labeled DNA hybridized with the genetic marker; and
a third step of determining a genotype of the labeled DNA as a risk genotype if a combination of the bases of both alleles of the labeled DNA identified in the second step is:
GG for rs2276015;
TT or Ct for rs2742946;
CC for rs1376264;
TT or CT for rs1126758; or
GG for rs2267437, and
predicting that the subject is predisposed to develop a late adverse reaction in a urinary organ after radiotherapy when the number of the risk genotypes is three or more and the subject is not predisposed to develop a late adverse reaction in a urinary organ after radiotherapy when the number of the risk genotypes is two or less.
